(19) United States
(12) Patent Application Publication
(10) Pub. No.: US 2023/0226678 A1
(43) Pub. Date: Jul. 20, 2023

(54) VIBRATION REDUCING STRUCTURE OF PNEUMATIC IMPACT TOOL

(71) Applicant: STORM PNEUMATIC TOOL CO., LTD., Taichung City (TW)

(72) Inventor: Yung Yung SUN, Taichung City (TW)

(21) Appl. No.: 17/579,828

(22) Filed: Jan. 20, 2022

(51) Int. Cl. B25D 17/24; B25F 5/00; B25D 9/08

(52) U.S. Cl. CPC B25D 17/24; B25F 5/006; B25D 9/08; B25D 2250/291

(57) ABSTRACT

A vibration reducing structure of pneumatic impact tool includes an outer shell, an inner tube member, a supporting ring and a gas sealing ring. An outer diameter of the inner tube member is slightly less than an inner diameter of the outer shell. The inner tube member is accommodated in the outer shell. A hammer member capable of being driven by high pressure gas to move is disposed in the inner tube member. A gas room is formed between the inner tube member and the outer shell. Both the supporting ring and the gas sealing ring surround the inner tube member. The supporting ring abuts against the outer shell so that a cylindrical gap communicated with the gas room is formed between the outer shell and the inner tube member. The gas sealing ring is closely engaged with the outer shell and the inner tube member to seal the cylindrical gap.

### BACKGROUND OF THE INVENTION

### 1. Technical Field

The present invention relates to a pneumatic impact tool and more particularly to a vibration reducing structure of pneumatic hammer.

### 2. Description of Related Art

Referring to FIG. 6, a conventional pneumatic impact tool includes a tube shell 91 with a rear end being blocked by a stopper 92. A base 93 which is configured to connect with a high pressure gas supplier is screwed to the tube shell 91. A hammer member 94 capable of being driven to move by high pressure gas is provided in the tube shell 91, and a tool member 95 generating work effort as a result of being hit by the hammer member 94 is provided at a front end of the tube shell 91. An elastic cushion member 96 is provided behind of the stopper 92 to reduce vibration caused by reciprocating movement of the hammer member 94. The cushion member 96, however, is pressed against the base 93 to be positioned by that the tube shell 91 is fixed with the base 93, so that the ability to deform for cushioning is limited.

A kind of conventional pneumatic hammers which use springs to reduce vibration disclosed in Taiwan Utility Patent No. 471377 and M467540 mainly includes a spring located behind a hammer member. In additional, Patent No. 471377 further recites another spring which is provided in front of the hammer member while Patent No. M467540 further recites an arc sheet which is provided in front of the hammer member. The hammer member that is driven by high pressure gas to move, accordingly, is cushioned by the spring when moving forward and is cushioned by the other spring or the arc sheet when moving backward so that vibration is reduced.

The hammer member 81, however, acts up to several thousand times per minute, that is, the spring or the arc sheet above-mentioned has to bear the deformations several thousand times in one minute. Owing to the nature limitation of material, the deformed spring or arc sheet fails to restore original size so quickly before suffering next compression so as to lower the effect upon vibration reducing.

### BRIEF SUMMARY OF THE INVENTION

The primary objective of the present invention is to provide a pneumatic impact tool featuring in that the inner tube member is surrounded by gas to be held firmly and stably, which facilitates vibration reduction.

To achieve the above objective, the present invention provides a vibration reducing structure of pneumatic impact tool including an outer shell, an inner tube member accommodated in the outer shell, a supporting ring and a gas sealing ring. The outer shell has a gas inlet and a gas inlet channel. A hammer member capable of being driven by high pressure gas to move is provided in the inner tube member. The inner tube member includes a less-in-diameter section and a greater-in-diameter section. An outer diameter of the greater-in-diameter section is less than an inner diameter of the outer shell. A gas room connected with the gas inlet channel is formed between a rear end of the greater-in-diameter section and a bottom end of the outer shell. Each of the supporting ring and the gas sealing ring surrounds the greater-in-diameter section and abuts against both the greater-in-diameter section and the outer shell. A cylindrical gap communicated with the gas room is formed between the outer shell and the greater-in-diameter section. The gas sealing ring is located at a position more than half a length of the greater-in-diameter section from the rear end of the greater-in-diameter section.

Preferably, a first gas channel communicated with the gas room is disposed in the inner tube member while a second gas channel is disposed in the hammer member. The second gas channel selectively connects with the first gas channel based on a position of the hammer member so that a moving direction of the hammer member is changed.

Preferably, extending directions of the outer shell, the inner tube member, the gas inlet channel and the first gas channel are all parallel to the moving direction of the hammer member.

Preferably, a stopper is screwed to the rear end of the greater-in-diameter section. The stopper has a protruding portion extending toward the gas room. The protruding portion is sleeved with a spring with one end abutting against the stopper and an opposite end abutting against a recess provided at the bottom end of the outer shell.

Preferably, the stopper is located at a central position of the rear end of the greater-in-diameter section. An interconnection of the gas inlet channel and the gas room is not aligned with the stopper.

Preferably, a front shell is fixed with the outer shell. A tool portion and an impacted portion connected with the tool portion are provided in the front shell. The impacted portion is configured to be hit by the hammer member.

Preferably, the less-in-diameter section of the inner tube member is sleeved with a cushion member abutted against the front shell.

Preferably, a front teeth portion is disposed at an end of the cushion member while a rear teeth portion is disposed at an opposite end of the cushion member. The front teeth portion and the rear teeth portion are staggered.

Preferably, a step portion is formed between the less-in-diameter section and the greater-in-diameter section. The gas sealing ring is disposed close to the step portion

### BRIEF DESCRIPTION OF THE SEVERAL VIEWS OF THE DRAWINGS

FIG. 1 is an exploded perspective view of the present invention;

FIG. 2 is a sectional view of the present invention;

FIG. 3A is an enlarged sectional view of part A in FIG. 1;

FIG. 3B is an enlarged sectional view of part B in FIG. 1;

FIG. 4 and FIG. 5 are sectional views of the present invention when in use; and

FIG. 6 is an exploded perspective view of a conventional structure.

### DETAILED DESCRIPTION OF THE INVENTION

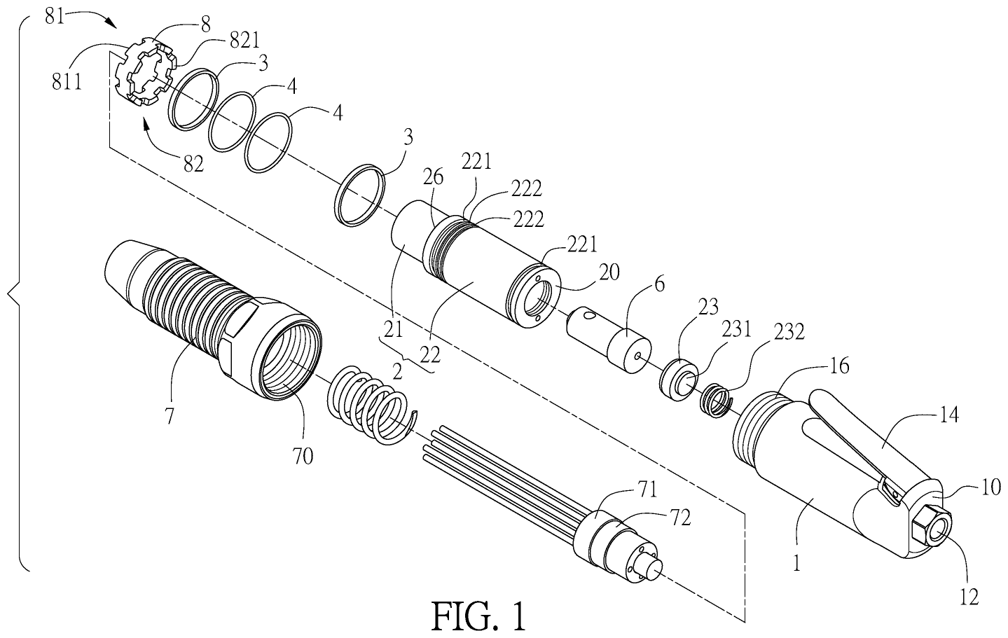

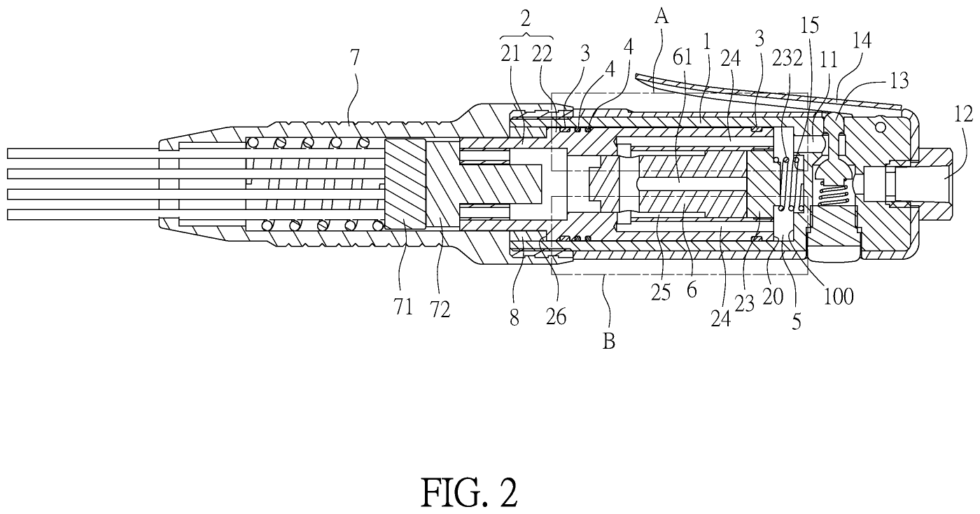

FIG. 1 and FIG. 2 show the vibration reducing structure of pneumatic impact tool according to the present invention. In this embodiment, it is a straight-type structure. The vibration reducing structure in the present invention includes an outer shell 1, an inner tube member 2, a supporting ring 3 and a gas sealing ring 4.

The outer shell 1 is straight. A gas inlet channel 11 is disposed in the outer shell 1. A gas inlet 12 configured to connect with a high pressure gas supplier is provided at a rear end of the outer shell 1. A control valve 13 is disposed in the gas inlet channel 11 for controlling gas to pass through. The control valve 13 can be operated by a trigger 14 located on the outer shell 1.

The inner tube member 2 includes a less-in-diameter section 21 and a greater-in-diameter section 22. A step portion 26 is formed between the less-in-diameter section 21 and the greater-in-diameter section 22. An outer diameter of the greater-in-diameter section 22 is slightly less than an inner diameter of the outer shell 1 so that the greater-in-diameter section 22 is accommodated in the outer shell 1. A gas room 5 is defined between a rear end 20 of the greater-in-diameter section 22 and a bottom end 100 of the outer shell 1. The gas inlet channel 11 connects to the gas room 5 in a shifted position from the center. A cylindrical gap 51 is formed between the greater-in-diameter section 22 and the outer shell 1. It is emphasized that the cylindrical gap 51 communicates with the gas room 5.

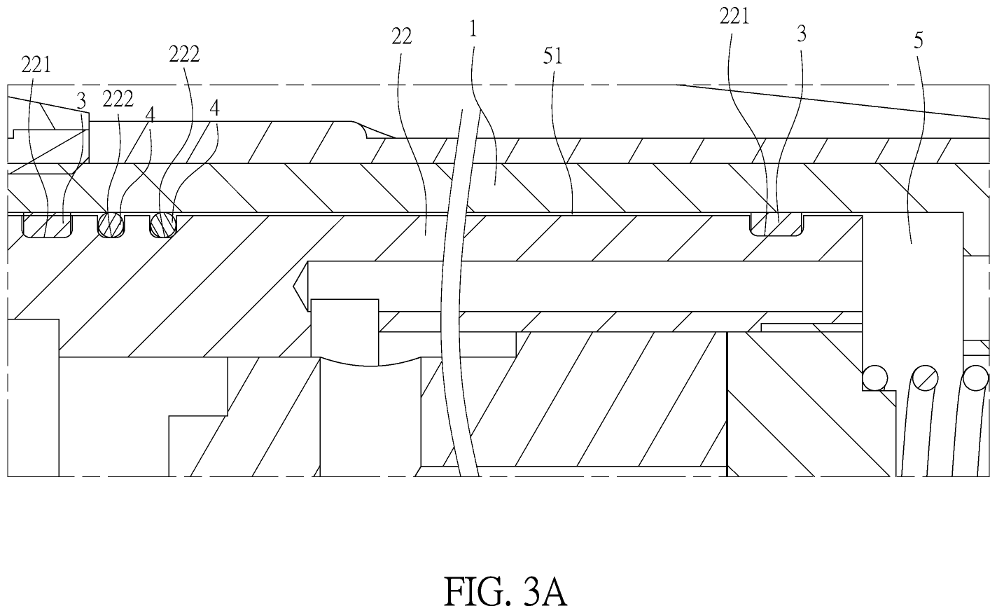

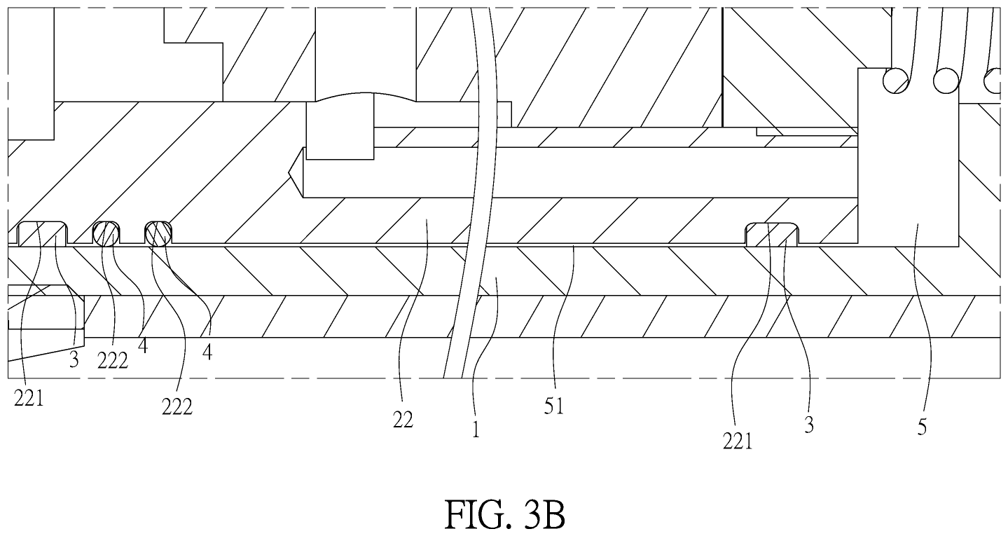

Two supporting rings 3 made of hard material for wear-resistance, e.g. polytetrafluoroethylene, surrounds the greater-in-diameter section 22. Referring to FIG. 3A and FIG. 3B, the supporting rings 3 abut against both the greater-in-diameter section 22 and the outer shell 1 so as to keep the inner tube member 2 held firmly and stably in the outer shell 1. In additional, the cylindrical gap 51 which is communicated with the gas room 5 is surely to exist. In this embodiment, the greater-in-diameter section 22 is provided with two first annular grooves 221 for embedding the supporting rings 3. Accordingly, when high pressure gas is guided into the gas room 5, the cylindrical gap 51 is also filled with high pressure gas so that the inner tube member 2 is surrounded.

Furthermore, at least one gas sealing ring 4 which is closely connected with both the greater-in-diameter section 22 and the outer shell 1 is provided for stopping gas flow. The gas sealing ring 4 is located at a position more than half a length of the greater-in-diameter section 22 from the rear end 20 of the greater-in-diameter section 22. Because there is constant friction between the gas sealing ring 4 and the outer shell 1 due to continuously vibration of the greater-in-diameter section 22, in this embodiment, there are two gas sealing rings 4 provided on the greater-in-diameter section 22 to enhance the stopping effect, avoiding the gas in the gas room 5 and the cylindrical gap 51 from leaking out. In this embodiment, as shown in FIG. 1 and FIG. 2, the gas sealing rings 4 are located close to the step portion 26 to make sure that a length of the cylindrical gap 51 is enough to surround the greater-in-diameter section 22. The greater-in-diameter section 22 is provided with two second annular grooves 222 for embedding the gas sealing rings 4.

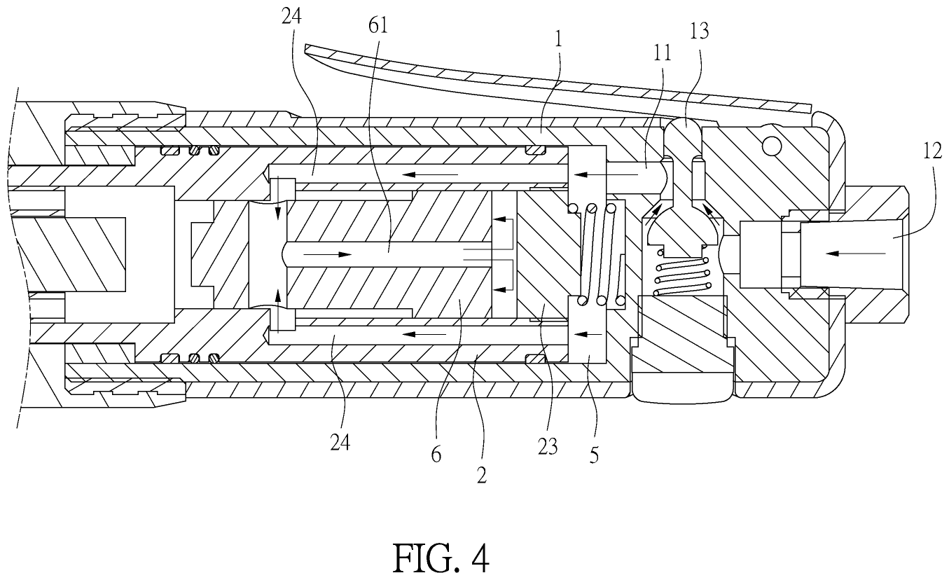

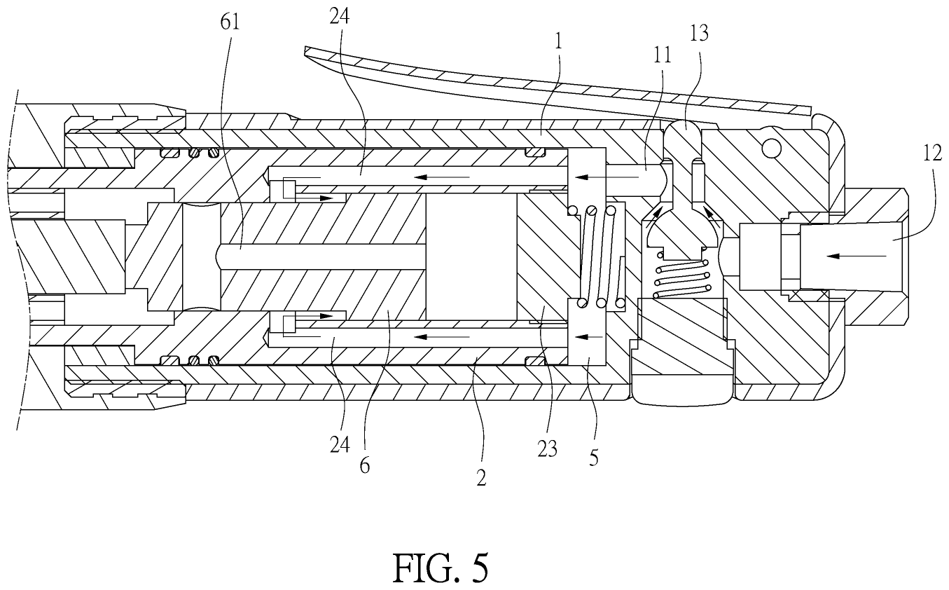

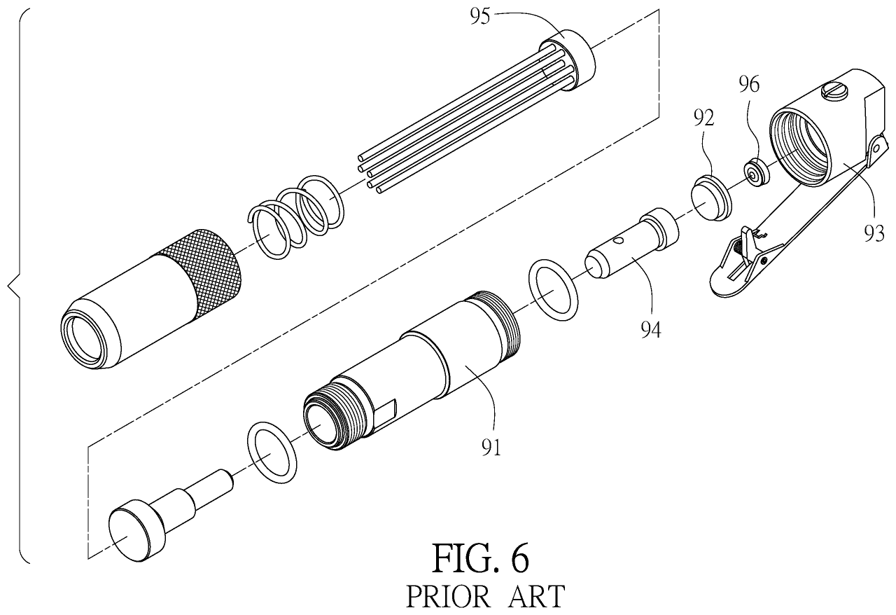

A stopper 23 is screwed in a central position of the rear end 20 of the greater-in-diameter section 22. The stopper 23 having a protruding portion 231 extending toward the gas room 5. The protruding portion 231 is sleeved with a spring 232 with one end abutting against the stopper 23 and an opposite end abutting against a recess 15 provided at the bottom end of the outer shell 1. The spring 232 is not aligned with the gas inlet channel 11. A first gas channel 24 communicating the gas room 5 and an inner space 25 of the inner tube member 2 is disposed in the inner tube member 2. A hammer member 6 capable of moving between a front position and a back position is provided in the inner space 25. A second gas channel 61 which is formed in T shape is disposed in the hammer member 6. When the hammer member 6 comes to the back position as shown in FIG. 4, the second gas channel 61 communicates with the first gas channel 24 so that high pressure gas firstly enters the second gas channel 61 through the first gas channel 24, and then rebounds on the stopper 23 to push the hammer member 6 forwardly. After that, when the hammer member 6 comes to the front position as shown in FIG. 5, the second gas channel 61 loses the communication with the first gas channel 24 so that high pressure gas pushes the hammer member 6 directly to move backwardly to the back position.

A front shell 7 is fixed at a front end of the outer shell 1 by threads 16, 70. The less-in-diameter section 21 of the inner tube member 2 is sleeved with a cushion member 8 abutted against both the front shell 7 and the step portion 26. The cushion member 8 is a rubber chunk or a spring to cushion vibration by deformation. In this embodiment, a front teeth portion 811 is disposed at a front end 81 of the cushion member 8 while a rear teeth portion 821 is disposed at a rear end 82 of the cushion member 8. The front teeth portion 811 and the rear teeth portion 821 are staggered for the cushion member 8 being deformed more easily to cushion vibration.

A tool portion 71 and an impacted portion 72 connected with the tool portion 71 are provided in the front shell 7. The tool portion 71 can be changed for other use. The impacted portion 72 engages with the tool portion 71 to be hit by the hammer member 6 and transports the impact force to the tool portion 71.

Extending directions of the outer shell 1, the inner tube member 2, the gas inlet channel 11 and the first gas channel 24 are all parallel to the moving direction of the hammer member 6, which makes the whole impact tool straight.

After high pressure gas is guided through the gas inlet channel 11, the gas room 5 and the first gas channel 24 in sequence and is injected into the inner space 25, the hammer member 6 is driven to move back and forth to hit the impacted portion 72 so that the tool portion 71 works. In the meanwhile, the inner tube member 2 vibrates. However in the present invention, when high pressure gas is guided into the gas room 5, the cylindrical gap 51 between the outer shell 1 and the inner tube member 2 is filled. Therefore, high pressure gas in the gas room 5 and the cylindrical gap 51 generates a holding force functioning on the inner tube member 2 to reduce vibration.

On the other hand, there is no shaking, as hard bodies hit each other, when gas suffers compression since gas is formless material. Moreover, the gas room 5 and the cylindrical gap 51 are filled with high pressure gas so that the gas functions on the greater-in-diameter section 22 uniformly to take the best effect upon vibration reducing.

What is claimed is:

1. A vibration reducing structure of pneumatic impact tool comprising:
an outer shell with a gas inlet and a gas inlet channel;
an inner tube member accommodated in the outer shell, a hammer member capable of being driven by high pressure gas to move being provided in the inner tube member, the inner tube member including a less-in-diameter section and a greater-in-diameter section, wherein an outer diameter of the greater-in-diameter section is less than an inner diameter of the outer shell, wherein a gas room connected with the gas inlet channel is formed between a rear end of the greater-in-diameter section and a bottom end of the outer shell;
a supporting ring surrounding the greater-in-diameter section and abutting against both the greater-in-diameter section and the outer shell, wherein a cylindrical gap communicated with the gas room is formed between the outer shell and the greater-in-diameter section; and
a gas sealing ring surrounding the greater-in-diameter section and abutting against both the greater-in-diameter section and the outer shell, wherein the gas sealing ring is located at a position more than half a length of the greater-in-diameter section from the rear end of the greater-in-diameter section.

2. The vibration reducing structure of pneumatic impact tool of claim 1, wherein a first gas channel communicated with the gas room is disposed in the inner tube member while a second gas channel is disposed in the hammer member, the second gas channel selectively connecting with the first gas channel based on a position of the hammer member so that a moving direction of the hammer member is changed.

3. The vibration reducing structure of pneumatic impact tool of claim 2, wherein extending directions of the outer shell, the inner tube member, the gas inlet channel and the first gas channel are all parallel to the moving direction of the hammer member.

4. The vibration reducing structure of pneumatic impact tool of claim 1, wherein a stopper is screwed to the rear end of the greater-in-diameter section, the stopper having a protruding portion extending toward the gas room, the protruding portion being sleeved with a spring with one end abutting against the stopper and an opposite end abutting against a recess provided at the bottom end of the outer shell.

5. The vibration reducing structure of pneumatic impact tool of claim 4, wherein the stopper is located at a central position of the rear end of the greater-in-diameter section, and an interconnection of the gas inlet channel and the gas room is not aligned with the stopper.

6. The vibration reducing structure of pneumatic impact tool of claim 1, wherein a front shell is fixed with the outer shell, a tool portion and an impacted portion connected with the tool portion being provided in the front shell, the impacted portion being configured to be hit by the hammer member.

7. The vibration reducing structure of pneumatic impact tool of claim 6, wherein the less-in-diameter section of the inner tube member is sleeved with a cushion member abutted against the front shell.

8. The vibration reducing structure of pneumatic impact tool of claim 7, wherein a front teeth portion is disposed at an end of the cushion member while a rear teeth portion is disposed at an opposite end of the cushion member, the front teeth portion and the rear teeth portion being staggered.

9. The vibration reducing structure of pneumatic impact tool of claim 1, wherein a step portion is formed between the less-in-diameter section and the greater-in-diameter section, and the gas sealing ring is disposed close to the step portion.
